(19) United States
(12) Patent Application Publication
(10) Pub. No.: US 2025/0122974 A1
(43) Pub. Date: Apr. 17, 2025

(54) HIGH-PRESSURE TANK AND METHOD AND APPARATUS OF PRODUCING SAME

(71) Applicant: HONDA MOTOR CO., LTD., Tokyo (JP)

(72) Inventors: Masanori HORI, Wako-shi (JP); Kosuke TATSUSHIMA, Wako-shi (JP)

(21) Appl. No.: 18/915,504

(22) Filed: Oct. 15, 2024

(30) Foreign Application Priority Data
Oct. 17, 2023 (JP) 2023-178639

(51) Int. Cl. F17C 1/06

(52) U.S. Cl. CPC F17C 1/06; F17C 2201/0109; F17C 2203/012; F17C 2203/0604; F17C 2203/0624; F17C 2203/0673; F17C 2209/2154; F17C 2209/232; F17C 2221/012; F17C 2270/0168; F17C 2270/0184

(57) ABSTRACT

Provided is a high-pressure tank in which rupture strength of a reinforcement layer can be improved more surely than in a conventional technique. The high-pressure tank includes a liner having a hollow interior and a reinforcement layer formed on an outer surface of the liner. The reinforcement layer includes unit layers stacked on the outer surface of the liner. A unit layer includes a band-shaped fiber bundle (band B) which includes a curable resin and is wound around the liner such that the band-shaped fiber bundle (band B) is disposed in line along a width of the unit layer. The band-shaped fiber bundle (band B) widens as the unit layers are stacked from an inner peripheral portion of the reinforcement layer to an outer peripheral portion of the reinforcement layer.

### CROSS REFERENCE TO RELATED APPLICATIONS

This application claims the foreign priority benefit under 35 U.S.C. § 119 of Japanese patent application No. 2023-178639, filed on Oct. 17, 2023, the disclosure of which is incorporated herein by reference.

### BACKGROUND OF THE INVENTION

### 1. Field of the Invention

The present invention relates to a high-pressure tank and a manufacturing method and a manufacturing apparatus of the high-pressure tank.

### 2. Description of the Related Art

As a high-pressure tank, there has been conventionally known a high-pressure tank that includes a reinforcement layer formed by winding a fiber containing a curable resin around the outer side of a liner with a substantially cylindrical shape having dome portions at both ends (For example, see PTL 1). This reinforcement layer of the high-pressure tank includes a helix layer in which the fiber is wound in a helix shape and a hoop layer that is provided on the outer side of the helix layer and in which the fiber is wound in a hoop shape. Moreover, in a manufacturing method of this high-pressure tank, tension of the fiber in formation of the hoop layer being an outer layer is set to be higher than tension of the fiber in formation of the helix layer being an inner layer. The high-pressure tank manufactured in the method as described above can suppress separation at an interface between the helix layer (inner layer) and the hoop layer (outer layer) also in the case where filling and discharging of a gas is repeatedly performed many times in a high-temperature high-humidity environment.

### CITATION LIST

### Patent Literature

PTL 1: JP2022-30873A

### SUMMARY OF THE INVENTION

However, in the conventional manufacturing method of the high-pressure tank (for example, see PTL 1), the tension of the fiber in the outer layer being higher than that of the fiber in the inner layer may possibly cause loosening of the fiber in the inner layer. If the fiber in the inner layer loosens, rupture strength of the reinforcement layer may decrease.

An object of the present embodiment is to provide a high-pressure tank in which rupture strength of a reinforcement layer can be improved more surely than in a conventional technique, and to provide a manufacturing method and a manufacturing apparatus of the high-pressure tank.

A high-pressure tank of the present invention achieving the above-mentioned object includes a liner having a hollow interior, and a reinforcement layer formed on an outer surface of the liner. The reinforcement layer includes a band-shaped fiber bundle which includes a curable resin and which is wound around the liner. A first width of the band-shaped fiber bundle closer to an outer peripheral portion of the reinforcement layer is wider than a second width of the band-shaped fiber bundle closer to an inner peripheral portion of the reinforcement layer.

A manufacturing method of the high-pressure tank of the present invention achieving the above-mentioned object is a method of producing a high-pressure tank including a liner having a hollow interior and a reinforcement layer on an outer surface of the liner. The method includes a winding step of stacking on the outer surface of the liner a band-shaped fiber bundle including a curable resin by winding the band-shaped fiber bundle around the outer surface of the liner, and a reinforcement layer forming step of forming the reinforcement layer by curing the curable resin included in the band-shaped fiber bundle wound around the outer surface. The winding step includes a step of widening the band-shaped fiber bundle such that the band-shaped fiber bundle closer to an outer peripheral portion of the reinforcement layer is wider than the band-shaped fiber bundle closer to an inner peripheral portion of the reinforcement layer.

A manufacturing apparatus of the high-pressure tank of the present invention achieving the above-mentioned object is an apparatus configured to produce a high-pressure tank including a liner having a hollow interior and a reinforcement layer on an outer surface of the liner. The apparatus includes a feeding mechanism configured to feed fiber bundles including a curable resin, and a winding mechanism configured to shape the fiber bundles fed from the feeding mechanism into a band-shaped fiber bundle by bundling the fiber bundles into an integrated body and configured to wind the band-shaped fiber bundle around the liner. The winding mechanism is configured to widen the band-shaped fiber bundle stacked on the reinforcement layer as the reinforcement layer extends from an inner peripheral portion of the reinforcement layer to an outer peripheral portion of the reinforcement layer.

The manufacturing method of the high-pressure tank of the present invention can improve rupture strength of the reinforcement layer more surely than in a conventional technique.

### BRIEF DESCRIPTION OF THE DRAWINGS

FIG. 1 is a vertical cross-sectional diagram of a high-pressure tank according to an embodiment of the present invention.

FIG. 2 is a partial enlarged horizontal plane diagram of the high-pressure tank according to the embodiment of the present invention.

FIG. 3 is a partial enlarged vertical cross-sectional diagram schematically showing a portion corresponding to the III portion in FIG. 1.

FIG. 4 is a diagram explaining a configuration of a manufacturing apparatus of the high-pressure tank according to the embodiment of the present invention.

FIG. 5A is an overall perspective diagram of one of first rollers forming a guide mechanism of a fiber bundle in the manufacturing apparatus of FIG. 4.

FIG. 5B is an overall perspective diagram of one of second rollers forming the guide mechanism of the fiber bundle in the manufacturing apparatus of FIG. 4.

FIG. 6 is a diagram explaining a configuration of a band width adjustment mechanism (combined width adjustment mechanism) in the manufacturing apparatus of FIG. 4.

FIG. 7 is an explanatory diagram of hoop winding of the fiber bundle performed in the manufacturing method according to the embodiment of the present invention.

FIG. 8A is a flowchart explaining a procedure executed by a controller forming the band width adjustment mechanism (combined width adjustment mechanism) of FIG. 6.

FIG. 8B is an explanatory diagram of a table referred to by the controller forming the band width adjustment mechanism (combined width adjustment mechanism) of FIG. 6.

FIG. 9 is an explanatory diagram of high-helix winding of the fiber bundle performed in the manufacturing method according to the embodiment of the present invention.

FIG. 10 is an explanatory diagram of low-helix winding of the fiber bundle performed in the manufacturing method according to the embodiment of the present invention.

FIG. 11 is an explanatory diagram of connector winding of the fiber bundle performed in the manufacturing method according to another embodiment of the present invention.

### DESCRIPTION OF EMBODIMENTS

Next, a mode (embodiment) for carrying out the present invention is explained in detail with reference to the drawings as appropriate. First, a high-pressure tank of the present embodiment is explained, and then a manufacturing apparatus and a manufacturing method of the high-pressure tank are explained.

### <<High-Pressure Tank>>

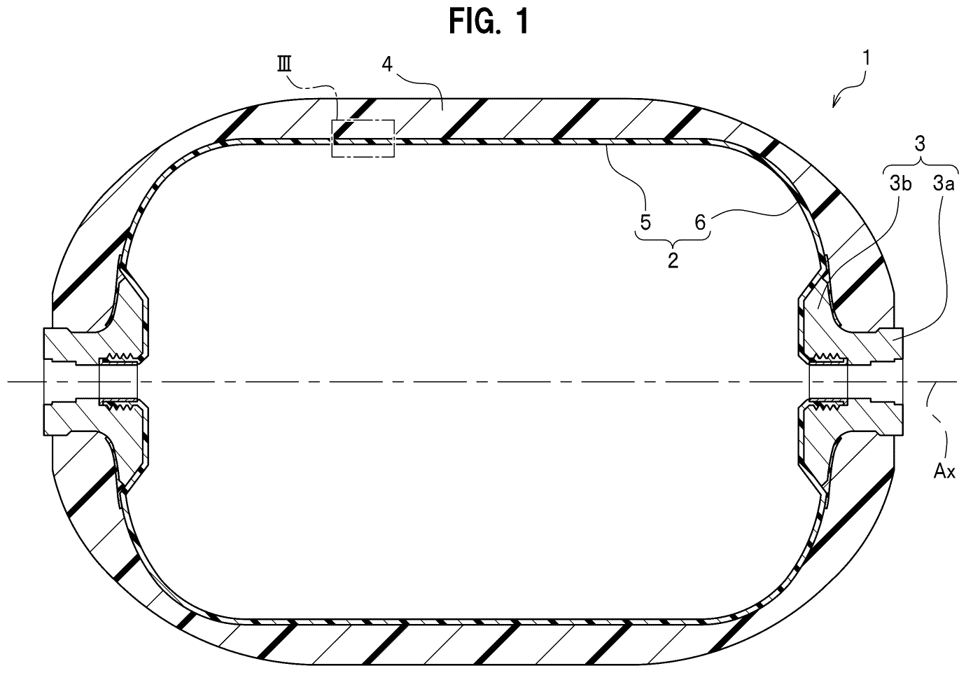

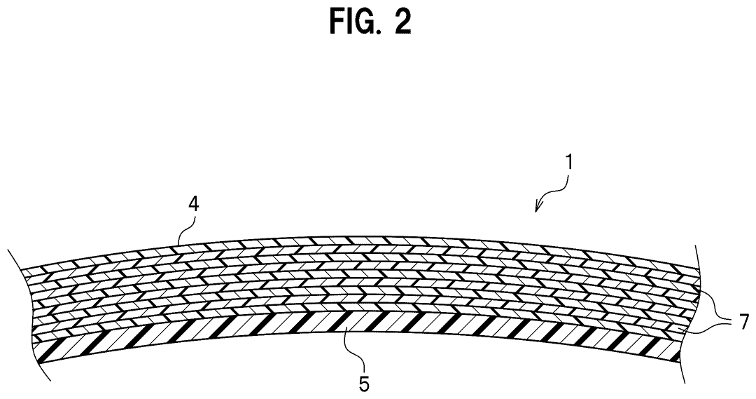

FIG. 1 is a vertical cross-sectional diagram of a high-pressure tank 1. FIG. 2 is a partial enlarged horizontal plane diagram of the high-pressure tank 1.

For example, the high-pressure tank 1 of the present embodiment is assumed to be a tank that is mounted in a fuel cell vehicle and that stores a hydrogen gas to be supplied to a fuel cell system. However, the high-pressure tank 1 is not limited to this tank, and may be a tank used for other high-pressure gases.

As shown in FIG. 1, the high-pressure tank 1 includes a liner 2, bosses 3 connected to the liner 2, and a reinforcement layer 4 covering the outer sides of the liner 2 and the bosses 3 to extend from the liner 2 to the bosses 3.

The bosses 3 are assumed to be, for example, bosses made of a metal material such as an aluminum alloy. Each boss 3 includes a cylindrical boss main body 3a having a feed-discharge hole on the inner side and a flange portion 3b formed on the one end side of the boss main body 3a in an axial direction thereof.

The liner 2 is a hollow body made of a thermoplastic resin. Examples of the thermoplastic resin include a polyamide resin, a polyethylene resin, and the like, but are not limited to the above.

The liner 2 of the present embodiment includes a cylindrical body portion 5 and dome portions 6 shaped integrally with both ends of the body portion 5.

As shown in FIG. 1, each dome portion 6 is a body with a flat bowl shape converging such that the diameter gradually decreases in a direction away from the body portion 5 toward the outer side in an axis Ax direction.

A center portion of each dome portion 6 in a radial direction thereof is caved in to correspond to the shape of the flange portion 3b of the boss 3.

As shown in FIG. 1, the reinforcement layer 4 is formed to extend from the outer surface of the liner 2 to the outer surfaces of the bosses 3.

As explained in detail later, the reinforcement layer 4 is formed by curing a curable resin included in a tow prepreg wound to extend from the liner 2 to the bosses 3.

Note that the tow prepreg in the present embodiment is made of fiber bundles (tows) of a reinforcement fiber including the curable resin, and has an adhesive property.

The curable resin of the tow prepreg is assumed to be a thermosetting resin such as, for example, an epoxy resin, a phenol resin, an unsaturated polyester resin, and a polyimide resin, but is not limited to these resins.

Moreover, examples of the reinforcement resin include a carbon fiber, a glass fiber, an aramid fiber, a boron fiber, an alumina fiber, a silicon carbide fiber, and the like, but are not limited to the above fibers.

As shown in FIG. 2, the reinforcement layer 4 is formed of multiple unit layers 7 stacked on the outer surface of the liner 2. The reinforcement layer 4 in the present embodiment is assumed to be formed of nine unit layers 7 in the body portion 5 of the liner 2. However, the number of the unit layers 7 is not limited to this.

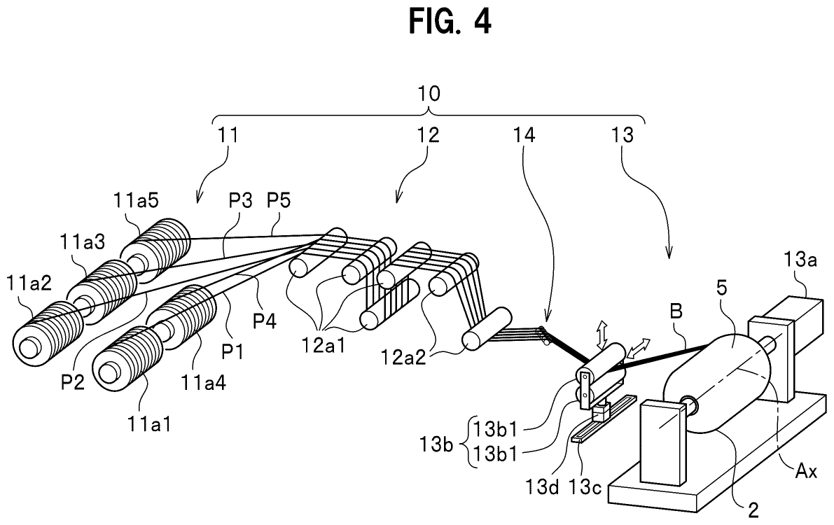

Each unit layer 7 is a layer formed by arranging a band B (see FIG. 4) that is a band-shaped fiber bundle fed from a band feeding head 13b (see FIG. 4) in a manufacturing apparatus 10 (see FIG. 4) to be described later in line in the axial direction of the liner 2 (direction perpendicular to the sheet surface of FIG. 2). The band B corresponds to a “band-shaped fiber bundle” referred to in the scope of claims.

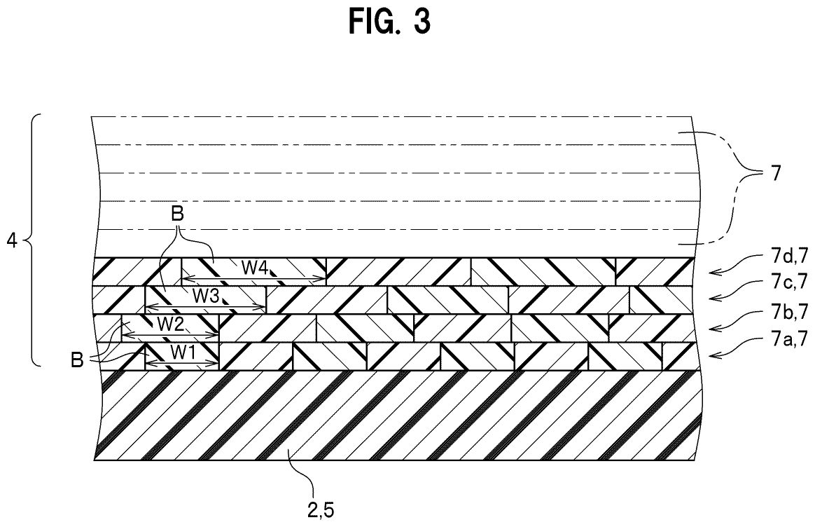

FIG. 3 is a partial enlarged vertical cross-sectional diagram schematically showing a portion corresponding to the III portion in FIG. 1.

As shown in FIG. 3, the reinforcement layer 4 in the present embodiment includes a first unit layer 7a, a second unit layer 7b, a third unit layer 7c, and a fourth unit layer 7d in this order from the outer peripheral surface side of the body portion 5 of the liner 2 in a vertical cross-sectional view along the axial direction of the liner 2. Moreover, five unit layers 7 are further stacked on an upper surface of the fourth unit layer 7d as shown by imaginary lines (two-dot-dash lines).

The first unit layer 7a in the present embodiment is formed by arranging the band B with a width W1 in line in the axial direction of the liner 2 (left-right direction on the sheet of FIG. 3).

The second unit layer 7b in the present embodiment is formed of the band B with a width W2. The third unit layer 7c is formed of the band B with a width W3. The fourth unit layer 7d is formed of the band B with a width W4.

Moreover, in the unit layers 7 forming the reinforcement layer 4, the width of the band B (hereinafter, simply referred to as “band width” in some cases) increases toward the outer side in a radial direction of the liner 2.

Specifically, the band widths of the first unit layer 7a, the second unit layer 7b, the third unit layer 7c, and the fourth unit layer 7d satisfy a relationship of “W1<W2<W3<W4” as shown in FIG. 3.

Moreover, although illustration is omitted, in the five unit layers 7 stacked on the upper surface of the fourth unit layer 7d, the band width increases toward the outer side in the radial direction of the liner 2.

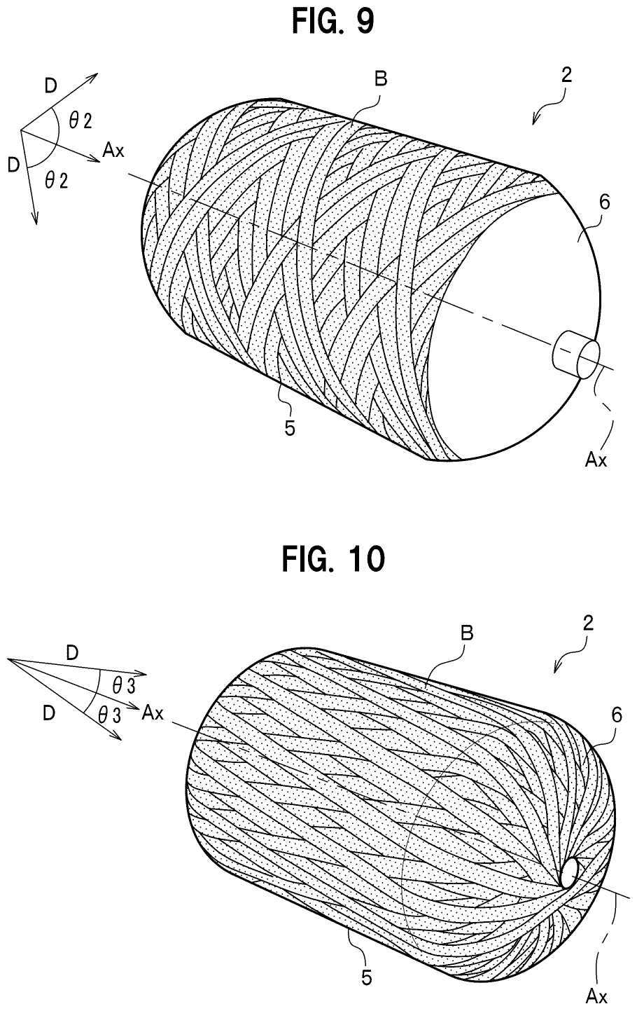

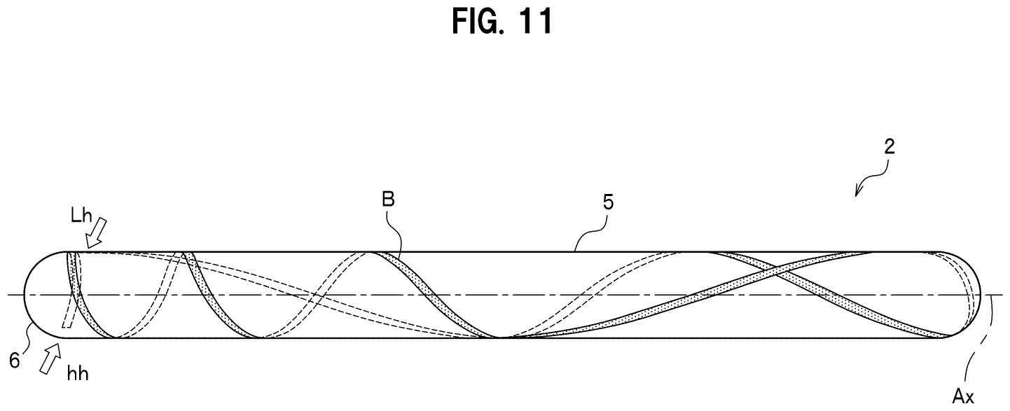

Note that each of the unit layers 7 shown in FIG. 3 is assumed to be a layer formed by winding the band B around the liner 2 in a hoop as described later (see FIG. 7). However, the configuration in which the band width increases toward the outer side in the radial direction of the liner 2 may be also applied to high-helix winding (see FIG. 9), low-helix winding (see FIG. 10), and the like as described later.

These unit layers 7 are integrated in a later-described reinforcement layer forming step in which the curable resin in the tow prepreg is cured.

### <<Apparatus of Producing High-Pressure Tank>>

Next, the manufacturing apparatus of the high-pressure tank 1 is explained.

FIG. 4 is a diagram explaining a configuration of the manufacturing apparatus 10.

As shown in FIG. 4, the manufacturing apparatus 10 is configured to mainly include a feeding mechanism 11 for a tow prepreg P1, a tow prepreg P2, a tow prepreg P3, a tow prepreg P4, and a tow prepreg P5, a guide mechanism 12 that guides the tow prepregs P1 to P5 fed from the feeding mechanism 11 to a winding mechanism 13, the winding mechanism 13 that bundles the tow prepregs P1 to P5 guided by the guide mechanism 12 into an integrated body to press-form the tow prepregs P1 to P5 into the band B with a predetermined width and that winds the band B around the liner 2, a band width adjustment mechanism 14 that adjusts intervals (combined width) between the tow prepregs P1 to P5 in advance such that the band B to be press-formed in the winding mechanism 13 has the predetermined width. Note that the band width adjustment mechanism 14 corresponds to “combined width adjustment mechanism” referred to in the scope of claims.

As shown in FIG. 4, the feeding mechanism 11 includes a bobbin 11al, a bobbin 11a2, a bobbin 11a3, a bobbin 11a4, and a bobbin 11a5 around which the tow prepregs P1 to P5 are wounded, respectively, in traverse winding and not-shown multiple bobbin motors that individually assist rotation of the bobbins 11al to 11a5 such that the tow prepregs P1 to P5 are pulled out at predetermined tension from the respective bobbins 11al to 11a5. Note that the feeding mechanism 11 in the present embodiment is assumed to be a mechanism including the five bobbins 11al to 11a5. However, the number of bobbins is not limited to this number, and can be changed accordingly as necessary.

As shown in FIG. 4, the guide mechanism 12 includes first rollers 12al and second rollers 12a2 between each two of which the tow prepregs P1 to P5 are spanned.

Although the guide mechanism 12 in the present embodiment includes four first rollers 12al and two second rollers 12a2, the numbers of the first rollers 12al and the second rollers 12a2 are not limited to these numbers, and can be changed accordingly as necessary.

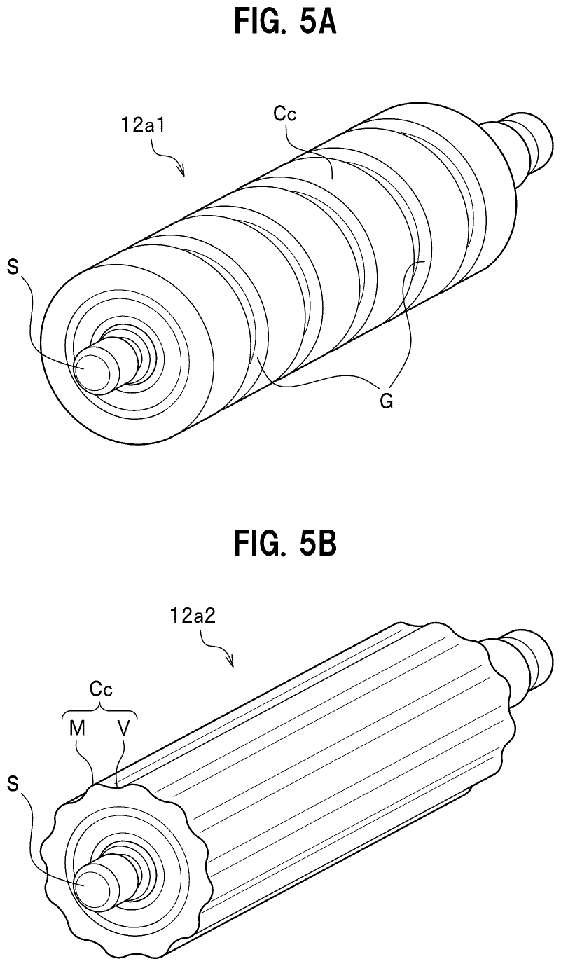

FIG. 5A is an overall perspective diagram of one of the first rollers 12a1. FIG. 5B is an overall perspective diagram of one of the second rollers 12a2.

As shown in FIG. 5A, the first roller 12al is a substantially-cylindrical body that rotates about a shaft S.

As shown in FIG. 5A, the first roller 12al individually guide each of the tow prepregs P1 to P5 (see FIG. 4) fed from the feeding mechanism 11 (see FIG. 4).

Multiple (five in the present embodiment) guide circumferential grooves G aligned in the shaft S direction are formed on a circumferential surface Cc of the first roller 12al. These guide circumferential grooves G each have a bottom surface that is flat in a groove width direction and that has a predetermined width. The tow prepregs P1 to P5 travel from the feeding mechanism 11 (see FIG. 4) on the upstream side toward the winding mechanism 13 (see FIG. 4) on the downstream side while coming into contact with the bottom surfaces of the guide circumferential grooves G. The cross-sectional shape of each of the tow prepregs P1 to P5 is thereby gradually flattened.

The first roller 12al (see FIG. 5A) as described above can be configured of divided rollers that individually guide the respective tow prepregs P1 to P5 (see FIG. 4).

As shown in FIG. 5B, the second rollers 12a2 are each a substantially cylindrical body that rotates about a shaft S.

Mountain portions M and valley portions V that extend in the shaft S direction are formed to be alternately arranged on a circumferential surface Cc of the second roller 12a2 in a circumferential direction. Moreover, top portions of the mountain portions M that come into contact with the tow prepregs P1 to P5 (see FIG. 4) are formed of smooth curved surfaces in a cross-sectional view intersecting the shaft S. Although the number of the mountain portions M in the present embodiment that are continuously arranged in the circumferential direction is set to 12, this number may be increased or reduced accordingly as necessary.

The second roller 12a2 (see FIG. 5B) as described above forms each of the tow prepregs P1 to P5 (see FIG. 4) into a plate shape. Note that the second roller 12a2 may be configured of divided rollers that correspond individually to the respective tow prepregs P1 to P5 (see FIG. 4).

As shown in FIG. 4, the four first rollers 12al in the present embodiment guide the tow prepregs P1 to P5 fed from the feeding mechanism 11 such that the intervals between the tow prepregs P1 to P5 are further reduced. The two second rollers 12a2 in the present embodiment further reduces the intervals between the tow prepregs P1 to P5 fed from the first roller 12a1 side, and guide the tow prepregs P1 to P5 to the band width adjustment mechanism 14 (see FIG. 4).

Next, the winding mechanism 13 (see FIG. 4) is explained before the band width adjustment mechanism 14 (see FIG. 4). As shown in FIG. 4, the winding mechanism 13 includes a drive unit 13a (rotation motor) that causes the liner 2 to rotate about an axis Ax and the band feeding head 13b that feeds the band B to the rotating liner 2.

The band feeding head 13b arranges the multiple (five) tow prepregs P1 to P5 formed into the plate shape in the guide mechanism 12 (second rollers 12a2) in the width direction, and integrates the tow prepregs P1 to P5. The band feeding head 13b thereby forms the band B that is band-shaped tow prepregs.

The band feeding head 13b is formed of paired pressing rollers 13b1, 13b1 arranged in parallel with a predetermined clearance provided therebetween. The five tow prepregs P1 to P5 arranged side by side and bundled upstream of the band feeding head 13b are press-formed to be integrated with one another upon passing between the paired pressing rollers 13b1, 13b1, and becomes the band B.

Moreover, the band feeding head 13b can move in the axis Ax direction of the liner 2 while feeding the band B to the rotating liner 2. Specifically, the band feeding head 13b moves in the axis Ax direction depending on a rotation operation of the liner 2 such that the unit layers 7 (see FIG. 2) described above are formed on the outer peripheral side of the liner 2. Moving means of the band feeding head 13b in the present embodiment is assumed to be a linear actuator 13c such as an air cylinder or a linear motor, but are not limited to these.

Moreover, the band feeding head 13b is configured to adjust tension of the band B to be supplied to the liner 2. Specifically, the band feeding head 13b adjusts load applied to the tow prepregs P in a direction intersecting a traveling direction of the tow prepregs P. Tension adjustment means of the band B in the present embodiment is assumed to be an interval adjustment actuator 13d provided between the linear actuator 13c and the band feeding head 13b. Although a rack-and-pinion mechanism that is driven by a rotation motor, an air cylinder, or the like can be given as the interval adjustment actuator 13d, the interval adjustment actuator 13d is not limited to these.

Moreover, the interval adjustment actuator 13d in the present embodiment is assumed to be an actuator that changes the position of the band feeding head 13b based on detected tenson of the tow prepregs P or the band B such that the detected tension becomes a target tension set in advance. Although a sensor that detects reaction force that the band feeding head 13b receives from the tow prepregs P or the band B can be given as means for detecting the tension of the tow prepregs P or the band B, the means for detecting the tension is not limited to this.

Note that the tension of the band B supplied to the liner 2 in the present embodiment is assumed to be constant from the start of the winding around the liner 2 to the end of the winding. However, the tension of the band B can be reduced toward the outer side in the radial direction of the liner 2.

Next, the band width adjustment mechanism 14 (see FIG. 4) is explained.

As shown in FIG. 4, the band width adjustment mechanism 14 adjusts the intervals between the five plate-shaped tow prepregs P1 to P5 fed from the guide mechanism 12 (second rollers 12a2) to the band feeding head 13b, that is the combined width of the tow prepregs P1 to P5 to be described later.

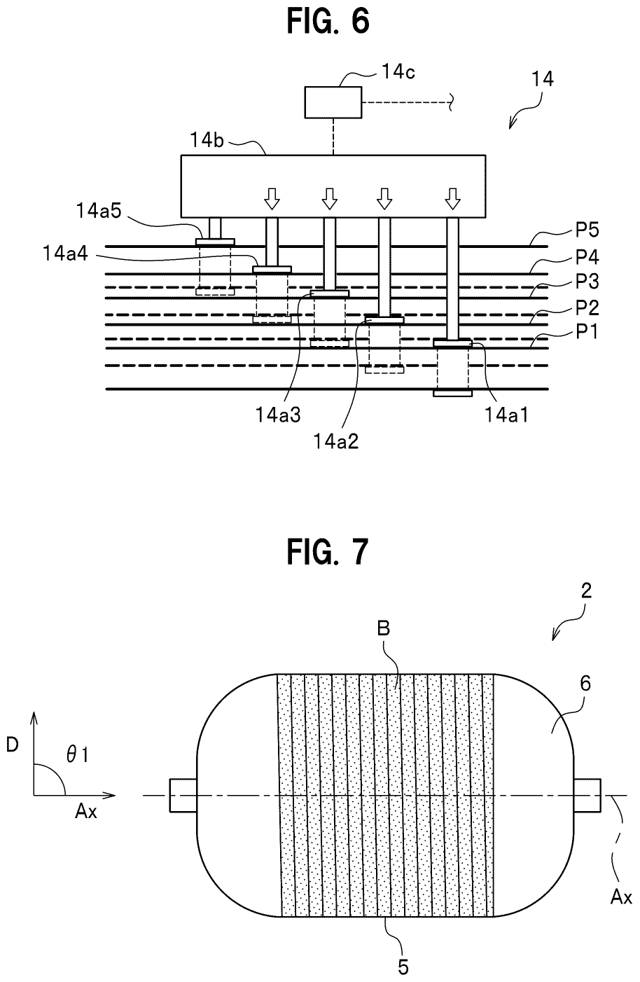

FIG. 6 is a diagram explaining a configuration of the band width adjustment mechanism 14 (see FIG. 4). FIG. 6 schematically shows a state where the band width adjustment mechanism 14 shown in FIG. 4 is looked down from above.

As shown in FIG. 6, the band width adjustment mechanism 14 is configured to mainly include five guide rollers of a guide roller 14a1, a guide roller 14a2, a guide roller 14a3, a guide roller 14a4, and a guide roller 14a5, an actuator 14b that adjusts intervals between the five guide rollers 14al to 14a5 in the axial direction, and a controller 14c that controls movement of the actuator 14b.

The guide rollers 14al to 14a5 are each formed of a H-type guide roller having flanges at both ends in an axial direction.

The guide rollers 14al to 14a5 are arranged in the order of the guide roller 14a1, the guide roller 14a2, the guide roller 14a3, the guide roller 14a4, and the guide roller 14a5 in a direction from the top to the bottom (in a direction from the closer side to the viewer toward the farther side on the paper sheet of FIG. 6).

The guide roller 14al guides the plate-shaped tow prepreg P1 toward the downstream side while restricting movement of the tow prepreg P1 in the width direction. The guide roller 14a2 guides the plate-shaped tow prepreg P2 toward the downstream side while restricting movement of the tow prepreg P2 in the width direction. The guide roller 14a3 guides the plate-shaped tow prepreg P3 toward the downstream side while restricting movement of the tow prepreg P3 in the width direction. The guide roller 14a4 guides the plate-shaped tow prepreg P4 toward the downstream side while restricting movement of the tow prepreg P4 in the width direction. The guide roller 14a5 guides the plate-shaped tow prepreg P5 toward the downstream side while restricting movement of the tow prepreg P5 in the width direction.

Specifically, the tow prepregs P1 to P5 are arranged in the order of the tow prepreg P1, the tow prepreg P2, the tow prepreg P3, the tow prepreg P4, and the tow prepreg P5 in the direction from the top to the bottom (in the direction from the closer side to the viewer to the farther side on the paper sheet of FIG. 6).

Moreover, the tow prepregs P1 to P5 are arranged while having predetermined overlapping areas as viewed in the up-down direction.

The actuator 14b moves the intervals of the guide rollers 14al to 14a4 in the axial direction relative to the guide roller 14a5.

As shown by the white arrows in FIG. 6, the actuator 14b individually moves the guide rollers 14a1 to 14a4 relative to the guide roller 14a5.

This increases the combined width of the tow prepregs P1 to P5 in the case where the tow prepregs P1 to P5 are viewed in the up-down direction as shown in FIG. 6. Moreover, although illustration is omitted, the actuator 14b can also reduce the combined width of the tow prepregs P1 to P5 by moving the guide rollers 14al to 14a4 relative to the guide roller 14a5 in a direction opposite to the white arrows shown in FIG. 6.

Although a rack-and-pinion mechanism that is driven by a rotation motor, an air cylinder, or the like can be given as the actuator 14b in the present embodiment, the actuator 14b is not limited to this.

The controller 14c can be configured to include a read only memory (ROM) that stores a program for controlling the actuator 14b, a random access memory (RAM) onto which the program stored in the ROM is read and loaded, and a central processing unit (CPU) that executes the loaded program and outputs a command to the actuator 14b.

The controller 14c increases the combined width of the tow prepregs P1 to P5 as shown in FIG. 6 according to the preset program. A procedure executed by the controller 14c is explained next together with the manufacturing method of the high-pressure tank.

### <<Method of Producing High-Pressure Tank>>

Next, the manufacturing method of the high-pressure tank 1 in the present embodiment is explained.

The manufacturing method in the present embodiment includes a winding step of winding the band B (see FIG. 4), that is the tow prepregs P1 to P5 (see FIG. 4) formed into the band shape, on the outer surface of the liner 2 (see FIG. 4) and a reinforcement layer forming step of forming the reinforcement layer 4 (see FIG. 2) by curing the curable resin included in the band B (tow prepregs P1 to P5) wound around the outer surface of the liner 2.

In this section, the manufacturing method in the present embodiment is specifically explained by using a method of winding the band B (see FIG. 3) around the body portion 5 (see FIG. 3) of the liner 2 (FIG. 3) in hoop winding, as an example.

FIG. 7 is an explanatory diagram of the hoop winding of the band B around the liner 2.

As shown in FIG. 4, the hoop winding is winding in which the band B is wound around the body portion 5 of the liner 2 in a hoop shape (ring shape). Specifically, in the hoop winding, an angle θ1 (winding angle) formed between an extending direction D of the band B forms and the axis Ax direction is set to an angle close to 90 degrees so that the band B is aligned in line in the axis Ax direction. The band B thereby forms the unit layer 7 (see FIG. 2) having substantially the same thickness as the band B, on the outer circumferential surface of the body portion 5 of the liner 2.

In the winding step, as shown in FIG. 3, multiple unit layers 7 are formed on the outer circumferential surface of the body portion 5 of the liner 2. This formation of the unit layers 7 in the hoop winding is performed by moving the band feeding head 13b in a reciprocate manner relative to the rotating liner 2 in a distance corresponding to the length of the body portion 5 of the liner 2 as shown in FIG. 4. Specifically, the odd-numbered unit layers 7 (see FIG. 3) are formed in an outbound route of the band feeding head 13b, and the even-numbered unit layers 7 (see FIG. 3) are formed in a return route.

The winding steps as described above is performed such that the band width increases toward the outer peripheral side of the reinforcement layer 4 (see FIG. 2). Specifically, the winding step is performed such that the band widths of the first unit layer 7a, the second unit layer 7b, the third unit layer 7c, and the fourth unit layer 7d satisfy the relationship of “W1<W2<W3<W4” as shown in FIG. 3. Moreover, also in the five unit layers 7 stacked on the upper surface of the fourth unit layer 7d, the winding step is performed such that the band width increases toward the outer side in the radial direction of the liner 2 as described above.

The increase of the width of the band B (see FIG. 4) in the band feeding head 13b (see FIG. 4) as described above is performed by causing the band width adjustment mechanism 14 to increase the above-mentioned combined width of the tow prepregs P1 to P5 fed from the guide mechanism 12 to the band feeding head 13b.

Specifically, the controller 14c of the band width adjustment mechanism 14 performs the increase of the width of the band B by controlling the actuator 14b according to a predetermined procedure.

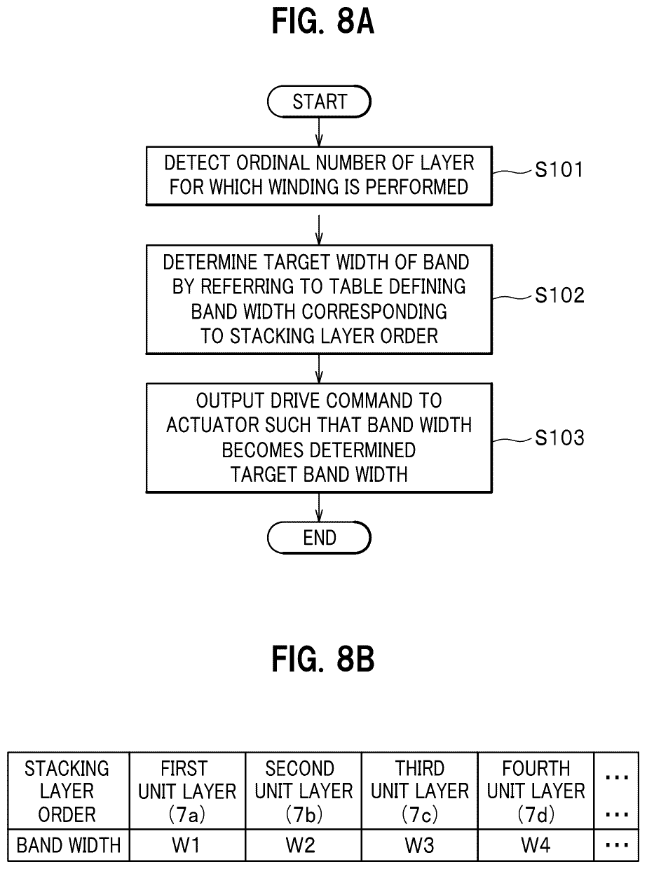

FIG. 8A is a flowchart explaining the procedure executed by the controller 14c (see FIG. 6). FIG. 8B is an explanatory diagram of a table referred to in the case where the controller 14c (see FIG. 6) executes the procedure.

As shown in FIG. 8A, the controller 14c (see FIG. 6) first detects the ordinal number of the layer for which the winding of the band B (see FIG. 3) around the liner 2 (see FIG. 3) is performed (see step S101).

For example, the controller 14c can detect the ordinal number of the layer for which the winding of the band B (see FIG. 3) is performed by: counting the number of times of reciprocating movement of the band feeding head 13b described above; storing this number in a predetermined memory; and reading the number from this memory.

Next, the controller 14c (see FIG. 6) determines the target width of the band B, that is the target band width by referring to the table shown in FIG. 8B (see step S102).

As shown in FIGS. 8A and 8B, the table defines in advance the band widths W1, W2, W3, and W4 (W1<W2<W3<W4) shown in FIG. 3 and the band widths in the not-shown respective unit layers 7 stacked on the upper surface of the fourth unit layer 7d that increase toward the outer side in the radial direction of the liner 2.

Then, in the case where the controller 14c (see FIG. 6) detects that the winding is performed for, for example, the third layer, the controller 14c sets the target band width to the width W3 of the band B corresponding to the third unit layer 7c that is the third layer in the stacking layer order in the table shown in FIG. 8B.

Next, as shown in FIG. 8A, the controller 14c (see FIG. 6) outputs a drive command to the actuator 14b (see FIG. 6) such that the band width becomes the determined target width (target band width) of the band B (see FIG. 4) (see step S103).

A sub-routine in which the controller 14c (see FIG. 6) controls the actuator 14b (see FIG. 6) is thereby completed.

Then, as shown in FIG. 6, the actuator 14b adjusts the combined width of the tow prepregs P1 to P5 sent from the guide mechanism 12 (see FIG. 4) to the band feeding head 13b (see FIG. 4) to the target band width based on the drive command from the controller 14c. As shown in FIG. 4, the band feeding head 13b press-forms the sent tow prepregs P1 to P5 as described above to feed the band B with the target band width toward the liner 2.

Meanwhile, the band feeding head 13b moves in a reciprocate manner in the distance corresponding to the length of the body portion 5 of the liner 2 to stack the multiple unit layers 7 on the body portion 5 of the liner 2 as shown in FIG. 3.

The band width in the formation of the unit layers 7 increases toward the outer side in the radial direction of the liner 2.

As shown in FIG. 7, the manufacturing method of the present embodiment is assumed to be configured such that the hoop winding of the band B is performed only on the body portion 5 of the liner 2, and then the band B is further wound by high-helix winding and low-helix winding.

FIG. 9 is an explanatory diagram of the high-helix winding of the band B (see FIG. 4). FIG. 10 is an explanatory diagram of the low-helix winding of the band B (see FIG. 4).

As shown in FIG. 9, in the high-helix winding, the band B (see FIG. 4) is set such that an angle θ2 (winding angle) formed between the extending direction D of the band B and the axis Ax direction is about 75 degrees. The band B is thereby wound around the body portion 5 of the liner 2 subjected to the hoop winding and peripheral edge portions of the dome portions 6 adjacent to the body portion 5 to extend across the body portion 5 and the peripheral edge portions.

As shown in FIG. 10, in the low-helix winding, the band B (see FIG. 4) is set such that an angle θ3 (winding angle) formed between the extending direction D of the band B and the axis Ax direction is about 10 degrees. The band B is thereby wound around the body portion 5 of the liner 2 subjected to the hoop winding and the high-helix winding and the entire dome portions 6 to extend across the body portion 5 and the dome portions 6.

Note that the band width in the high-helix winding and the band width in the low-helix winding in the manufacturing method of the present embodiment are set to be the same as the band width in the hoop winding of the outer-most layer. However, the band width in the high-helix winding and the band width in the low-helix winding may be configured to be increased toward the outer peripheral side of the reinforcement layer 4 (see FIG. 1).

In the reinforcement layer forming step, the liner 2 (see FIG. 4) for which the winding step is completed is removed from the winding mechanism 13 (see FIG. 4), and is heated to predetermined temperature in a heating furnace (illustration is omitted).

This cures the curable resin included in the band B (see FIG. 4) wound around the liner 2. The multiple unit layers 7 (see FIG. 3) laid one on top of another are integrated and firmly adhere to the outer surface of the liner 2 in a process of curing of the curable resin. The reinforcement layer 4 (see FIG. 1) is thereby formed, and the series of steps of manufacturing the high-pressure tank 1 is completed.

### <<Operations and Effects>>

Next, operations and effects provided by the high-pressure tank 1 according to the present embodiment and by the manufacturing method and the manufacturing apparatus 10 of the high-pressure tank 1 are explained.

In the high-pressure tank 1 of the present embodiment, the width of the band B (band-shaped fiber bundle) closer to an outer peripheral portion of the reinforcement layer 4 is increased from that closer to an inner peripheral portion.

According to this high-pressure tank 1, increasing the width of the band B closer to the outer peripheral portion from that closer to the inner peripheral portion reduces surface pressure (pressure per unit area of the band B) that the band B closer to the outer peripheral portion applies to the band B closer to the inner peripheral portion. According to this high-pressure tank 1, loosening of the fibers in the band B on the inner layer side is suppressed unlike in a conventional high-pressure tank (for example, see PTL 1).

In the high-pressure tank 1, rupture strength of the reinforcement layer 4 can be thus improved more surely than in a conventional technique.

Moreover, in the high-pressure tank 1 as described above, the reinforcement layer 4 includes the multiple unit layers 7 stacked on the outer surface of the liner 2. Furthermore, the unit layers 7 are formed by winding the band B (band-shaped fiber bundle) around the liner 2 in line in the width direction. Moreover, the width of band B in the unit layer 7 stacked closer to the outer peripheral portion of the reinforcement layer 4 is increased from that closer to the inner peripheral portion.

According to this high-pressure tank 1, since the width of the band B is increased every layer of the stacked unit layers 7, the rupture strength of the reinforcement layer 4 can be further surely improved.

Moreover, in the high-pressure tank 1 as described above, the liner 2 is configured to include the cylindrical body portion 5 and the dome portions 6 at both ends of the body portion 5. Moreover, the multiple unit layers 7 are formed only on the body portion 5 of the liner 2.

According to this high-pressure tank 1, performing the winding of the bands B on the body portion 5 more concentratedly than that on the dome portions 6 that have relatively higher strength against inner pressure of the high-pressure tank 1 allows the strengthening of the entire high-pressure tank 1 by the reinforcement layer 4 to be performed more efficiently.

The manufacturing method of the high-pressure tank 1 in the present embodiment includes the winding step of stacking the band B (band-shaped fiber bundle including the curable resin) on the outer surface of the liner 2 by winding the band B around the outer surface of the liner 2 and the reinforcement layer forming step of forming the reinforcement layer 4 by curing the curable resin included in the band B wound around the outer surface, and the winding step includes the step of widening the band B such that the band B closer to the outer peripheral portion of the reinforcement layer 4 is wider than that closer to the inner peripheral portion of the reinforcement layer 4.

According to the manufacturing method of the high-pressure tank 1 as described above, the high-pressure tank 1 in which the rupture strength of the reinforcement layer 4 is improved more surely than in a conventional technique can be manufactured.

Moreover, in the manufacturing method as described above, the winding step is performed by the hoop winding of the band B (band-shaped fiber bundle) around the body portion 5 of the liner 2.

According to this manufacturing method, since the band B is wound around the body portion 5 of the liner 2 such that the band B forms a substantially right angle with respect to the axis Ax of the liner 2, the band B can more effectively contribute to the improvement of the rupture strength of the reinforcement layer 4.

The manufacturing apparatus 10 of the high-pressure tank 1 in the present embodiment includes the feeding mechanism 11 that feeds the tow prepregs P1 to P5 (plurality of fiber bundles including the curable resin) and the winding mechanism 13 that shapes the tow prepregs P1 to P5 fed from the feeding mechanism 11 into the band B (band-shaped fiber bundle) by bundling the tow prepregs P1 to P5 into an integrated body and that winds the band B around the liner 2. Moreover, the winding mechanism 13 is configured to increase the width of the band B stacked closer to the outer peripheral portion of the reinforcement layer 4 from that closer to the inner peripheral portion.

This manufacturing apparatus can manufacture the high-pressure tank 1 in which the rupture strength of the reinforcement layer 4 is improved more surely than in a conventional technique.

The manufacturing apparatus 10 as described above further includes the guide mechanism 12 that flattens the cross-sectional shape of the tow prepregs P1 to P5 (plurality of fiber bundles including the curable resin) to the plate shape while guiding the tow prepregs P1 to P5 from the feeding mechanism 11 to the winding mechanism 13 and the band width adjustment mechanism 14 (combined width adjustment mechanism) that sets the combined width of the flattened tow prepregs P1 to P5 to the width of the band B (band-shaped fiber bundle) to be wound around the liner 2 by the winding mechanism 13.

According to this manufacturing apparatus 10, the winding mechanism 13 can more accurately increase the width of the band B stacked closer to the outer circumferential portion of the reinforcement layer 4 from that closer to the inner peripheral portion.

Although the embodiment of the present invention has been explained above, the present invention is not limited to the above-mentioned embodiment, and can be carried out in various modes.

In the manufacturing method of the above-mentioned embodiment, explanation is given of the method including the step of performing the high-helix winding and the low-helix winding after the hoop winding of the band B around the liner 2.

However, the order of the hoop winding, the high-helix winding, and the low-helix winding that are winding methods of the band B around the liner 2 can be changed.

Moreover, although the increase of the width of the band B in the above-mentioned embodiment is assumed to be applied only to the hoop winding performed around the body portion 5 of the liner 2, the width of the band B is increased as long as the band width in at least part of the band B in at least one of the hoop winding, the high-helix winding, and the low-helix winding is increased from the band width of the band B which is wound and is closer to an inner peripheral portion of the reinforcement layer 4 than the at least part.

Moreover, in the winding step in the manufacturing method of the above-mentioned embodiment, the hoop winding and the helix winding are combined along the layer thickness of the reinforcement layer 4, and the winding angles θ1, θ2, and θ3 (see FIGS. 7, 9, and 10) of the band B (band-shaped fiber bundle) with respect to the liner 2 vary.

Assume that, in the manufacturing method of the high-pressure tank 1, the order of the hoop winding, the high-helix winding, and the low-helix winding that are the methods of winding the band B around the liner 2 is changed. In this case, the winding angle of the band B changes from θ1 to θ2 or θ3, from θ2 to θ1 or θ3, or from θ3 to θ1 or θ2.

In such a manufacturing method, before the change of the winding angle of the band B, there may be interposed connector winding in which the band B is wound around the liner 2 at a winding angle between the winding angle before the change and the winding angle after the change.

FIG. 11 is an explanatory diagram of the connector winding of the band B. Note that, in FIG. 11, the body portion 5 of the liner 2 is drawn to be longer than the actual body portion 5 in the axis Ax direction for the convenience of illustration. In this case, the connector winding of the band B is explained by using the case where the winding is changed from the low-helix winding (see FIG. 10) to the hoop winding (see FIG. 7) as an example.

In FIG. 11, reference sign Lh denotes a position of winding end of the low-helix winding (see FIG. 10) around the liner 2. Reference sign hh denotes a position of winding start of the hoop winding (see FIG. 7) around the liner 2.

As shown in FIG. 11, in the case where the winding method is changed from the low-helix winding (see FIG. 10) at the winding angle θ3 to the hoop winding (see FIG. 7) at the winding angle θ1, the band B in the connector winding is wound around the liner 2 to make a round trip from the position Lh of the winding end of the low-helix winding (see FIG. 10) set on one end side of the axis Ax of the liner 2 to the position hh of the winding start of the hoop winding (see FIG. 7) set in an end portion of the body portion 5 at the other end.

Then, while the band B in the connector winding makes the round trip, the band B is wound around the liner 2 such that the winding angle gradually changes to a winding angle between the winding angle θ3 (see FIG. 10) before the change and the winding angle θ1 (see FIG. 7) after the change, specifically, the winding angle exceeds 03 and gradually changes from the winding angle θ3 to the winding angle θ1 without exceeding 01.

According to the connector winding (see FIG. 11) as described above, winding slip of the band B due to a change in the winding angle can be prevented.

Moreover, in the manufacturing method of the present embodiment in which the connector winding (see FIG. 11) as described above is interposed, the width of the band B in the connector winding may be configured to be increased from the width of the band B closer to the inner peripheral portion.

Specifically, the winding step in the manufacturing method is performed by combining the hoop winding and the helix winding along the layer thickness of the reinforcement layer 4 such that the winding angle of the band B (band-shaped fiber bundle) relative to the outer surface of the liner 2 is changed. Moreover, before the change of the winding angle, there is interposed the connector winding in which the band B (band-shaped fiber bundle) is wound at a winding angle between the winding angle before the change and the winding angle after the change, and the width of the band B (band-shaped fiber bundle) in the connector winding is wider than the width of the band B (band-shaped fiber bundle) which is closer to the inner peripheral portion of the reinforcement layer than the band B (band-shaped fiber bundle) in the connector winding.

According to the manufacturing method as described above, the winding slip of the band B is suppressed also in the case where the reinforcement layer 4 is formed by a winding method in which the winding angle of the band B changes. The high-pressure tank 1 in which the rupture strength of the reinforcement layer 4 is further improved can be thereby manufactured.

It is understood that the foregoing description is that of the preferred embodiments of the invention and that various changes and modifications may be made thereto without departing from the spirit and scope of the invention as defined in the appended claims.

What is claimed is:

1. A high-pressure tank comprising:
a liner having a hollow interior; and
a reinforcement layer formed on an outer surface of the liner,
wherein the reinforcement layer includes a band-shaped fiber bundle which includes a curable resin and which is wound around the liner, and
wherein a first width of the band-shaped fiber bundle closer to an outer peripheral portion of the reinforcement layer is wider than a second width of the band-shaped fiber bundle closer to an inner peripheral portion of the reinforcement layer.

2. The high-pressure tank according to claim 1, wherein the reinforcement layer further includes unit layers stacked on the outer surface of the liner,
wherein a unit layer includes the band-shaped fiber bundle wound around the liner such that the band-shaped fiber bundle is disposed in line along a width of the unit layer, and
wherein the band-shaped fiber bundle widens as the unit layers are stacked from the inner peripheral portion of the reinforcement layer to the outer peripheral portion of the reinforcement layer.

3. The high-pressure tank according to claim 2, wherein the liner includes dome portions and a body portion which has a cylindrical shape,
wherein the dome portions are disposed on opposite ends of the body portion, and
wherein the unit layers are disposed only on the body portion and not disposed on the dome portions.

4. A method of producing a high-pressure tank including a liner having a hollow interior and a reinforcement layer on an outer surface of the liner, the method comprising:
a winding step of stacking on the outer surface of the liner a band-shaped fiber bundle including a curable resin by winding the band-shaped fiber bundle around the outer surface of the liner; and
a reinforcement layer forming step of forming the reinforcement layer by curing the curable resin included in the band-shaped fiber bundle wound around the outer surface, and
wherein the winding step includes a step of widening the band-shaped fiber bundle such that the band-shaped fiber bundle closer to an outer peripheral portion of the reinforcement layer is wider than the band-shaped fiber bundle closer to an inner peripheral portion of the reinforcement layer.

5. The method according to claim 4, wherein the winding step is performed by hoop winding the band-shaped fiber bundle around a body portion of the liner.

6. The method according to claim 4, wherein the winding step is performed by combining hoop winding and helix winding along a layer thickness of the reinforcement layer such that a winding angle of the band-shaped fiber bundle relative to the outer surface of the liner is changed,
wherein, before changing the winding angle, connector winding in which the band-shaped fiber bundle is wound at an angle between the winding angle and a changed winding angle is interposed, and
wherein the band-shaped fiber bundle is widened such that a first width of the band-shaped fiber bundle in the connector winding is wider than a second width of the band-shaped fiber bundle which is closer to the inner peripheral portion of the reinforcement layer than the band-shaped fiber bundle in the connector winding.

7. An apparatus configured to produce a high-pressure tank including a liner having a hollow interior and a reinforcement layer on an outer surface of the liner, the apparatus comprising:
a feeding mechanism configured to feed fiber bundles including a curable resin; and
a winding mechanism configured to shape the fiber bundles fed from the feeding mechanism into a band-shaped fiber bundle by bundling the fiber bundles into an integrated body and configured to wind the band-shaped fiber bundle around the liner; and
wherein the winding mechanism is configured to widen the band-shaped fiber bundle stacked on the reinforcement layer as the reinforcement layer extends from an inner peripheral portion of the reinforcement layer to an outer peripheral portion of the reinforcement layer.

8. The apparatus according to claim 7, further comprising:
a guide mechanism configured to flatten a fiber bundle into a plate shape in a cross-sectional shape while guiding the fiber bundles from the feeding mechanism to the winding mechanism; and
a combined width adjustment mechanism configured to set a combined width of flattened fiber bundles to a width of the band-shaped fiber bundle to be wound around the liner by the winding mechanism.
